(19) United States
(12) Patent Application Publication
(10) Pub. No.: US 2008/0072265 A1
(43) Pub. Date: Mar. 20, 2008

(54) METHOD AND APPARATUS FOR PROCESSING PLURALITY OF APPLICATIONS FOR BROADCASTING SERVICE AND INFORMATION STORAGE MEDIUM STORING THE METHOD

(75) Inventors: Kwang-hyuk Kim, Suwon-si (KR); Keum-yong Oh, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/857,673

(22) Filed: Sep. 19, 2007

(30) Foreign Application Priority Data
Sep. 19, 2006 (KR) 10-2006-0090469
Sep. 11, 2007 (KR) 10-2007-0092140

(51) Int. Cl. H04N 7/173

(52) U.S. Cl. 725/105

(57) ABSTRACT

A method and apparatus for generating a plurality of application included in a broadcasting service and a method and apparatus for selecting an application easily processed by a broadcasting receiving apparatus among the plurality of applications and executing or storing the selected application are provided. The application generating and signaling apparatus includes: an application generator generating a plurality of applications selectively executed by a broadcasting receiving apparatus and information on each of the plurality of applications; and an application transmitter signaling the plurality of applications and the information on each of the plurality of applications, wherein the information on each of the plurality of applications comprises information on the broadcasting receiving apparatus that executes a corresponding application, and information on the characteristics of the corresponding application.

### CROSS REFERENCE TO RELATED APPLICATIONS

This application claims priority from Korean Patent Application Nos. 10-2006-0090469 and 10-2007-0092140, filed on Sep. 19, 2006 and Sep. 11, 2007, respectively, in the Korean Intellectual Property Office, the disclosures of which are incorporated herein in its entirety by reference.

### BACKGROUND OF THE INVENTION

1. Field of the Invention

Apparatuses and methods consistent with the present invention relate to data broadcasting, and more particularly, to generating, executing, signaling, and storing a plurality of applications.

2. Description of the Related Art

Data broadcasting provides general information relating to broadcasting programs, living information, Internet access, electronic commerce, bi-directional entertainment in addition to existing broadcasting programs using broadcasting networks such as ground waves, satellite, or cable, etc. International data broadcasting specifications include the open cable application platform (OCAP), the advanced common application platform (ACAP), the multimedia home platform (MHP), etc.

FIG. 1 is a diagram of a related art illustrating that one application is transmitted to one broadcasting receiving apparatus. Referring to FIG. 1, a data broadcasting apparatus 110 transmits a broadcasting signal 130 which includes an application 132, an application information table (AIT) 133 relating to the application 132, and an audio and video (AV) data stream 131 to a data broadcasting receiving apparatus 120. The application 132 is an application program executed based on a Java virtual machine (JVM) of a broadcasting receiver. The application 132 transmitted from the data broadcasting apparatus 110 is loaded on an application processor 121 of the data broadcasting receiving apparatus 120 and processed. Broadcasting including media data such as AV data and the application as well provides a user with various pieces of information relating to the media data.

FIG. 2 is a diagram of a related art illustrating that one application is stored in one broadcasting receiving apparatus. Referring to FIG. 2, a data broadcasting apparatus 210 transmits an application recording descriptor 234 included in an AIT 233 when transmitting an AV data stream 231 and an application 232 relating to the AV data stream 231. If the application recording descriptor 234 included in the AIT 233 is signaled, the data broadcasting recording apparatus 220 automatically records the application 232 in a hard disk 222 when recording a broadcasting service.

However, applications having one object mostly aim at one type of broadcasting receiving apparatus. Generally, applications having one object aim at a broadcasting receiving apparatus having a large display. Therefore, there is no application suitable for a broadcasting receiving apparatus in different form, e.g. a small mobile device.

### SUMMARY OF THE INVENTION

The present invention provides an application generating and signaling method and apparatus for transmitting a plurality of applications aiming at broadcasting receiving apparatuses having various forms.

The present invention also provides a method and apparatus for selecting and processing an application suitable for a broadcasting receiving apparatus and/or a user when a plurality of applications are transmitted to the broadcasting receiving apparatus and executing the selected application.

The present invention also provides an application selecting and storing method and apparatus for selecting and recording an application suitable for a broadcasting receiving apparatus and/or another broadcasting receiving apparatus at home when a plurality of applications are transmitted to the broadcasting receiving apparatus and executing the selected application.

According to an aspect of the present invention, there is provided an application generating and signaling apparatus comprising: an application generator generating a plurality of applications selectively executed by a broadcasting receiving apparatus and information on each of the plurality of applications; and an application transmitter signaling the plurality of applications and the information on each of the plurality of applications, wherein the information on each of the plurality of applications comprises information on the broadcasting receiving apparatus that may execute a corresponding application, and information on the characteristics of the corresponding application.

The information on the characteristics of the corresponding application may comprise information on at least one of a style of the corresponding application, a rank of a user, a language of the user, and an age of the user.

According to another aspect of the present invention, there is provided an application generating and signaling apparatus comprising: an application generator generating a plurality of applications selectively executed by a broadcasting receiving apparatus and information on each of the plurality of applications; and an application transmitter signaling the plurality of applications and the information on each of the plurality of applications, wherein the information on each of the plurality of applications comprises at least one of identification information and version information on the broadcasting receiving apparatus and extended information on other characteristics of the broadcasting receiving apparatus.

The extended information may comprise information on at least one of the recording characteristics of the broadcasting receiving apparatus, the characteristics of a multi-screen manager system (MSM), a type of an input device, and graphic characteristics.

The recording characteristics of the broadcasting receiving apparatus may comprise information on at least one of the number of tuners, the number of simultaneous reproductions, the number of simultaneous recordings, the number of storage media, and the size of a storage medium.

The characteristics of the MSM may comprise information on at least one of whether the broadcasting receiving apparatus supports the MSM and the number of multi-screens.

The graphic characteristics may comprise information on at least one of graphic resolution and the color characteristics of the broadcasting receiving apparatus.

The information on each of the plurality of applications may comprise component tags that are information on carousel corresponding to a corresponding application, wherein the application transmitter includes association tags that are linked to the component tags in a program map table of a stream included in the corresponding application.

According to another aspect of the present invention, there is provided an application selecting and executing apparatus comprising: an application information analyzer analyzing information on each of a plurality of applications providing a broadcasting service; an application selector selecting an application suitable for a broadcasting receiving apparatus among the plurality of applications based on the analysis; and an application executor executing the selected application wherein the application selector compares information on the broadcasting receiving apparatus that executes the selected application included in the information on each of the plurality of applications with information on the broadcasting receiving apparatus that receives the selected application, if a plurality of applications are determined to be suitable for the broadcasting receiving apparatus that receives the selected application, receives information on user's characteristics, and compares information on the characteristics of the selected application included in the information on each of the plurality of applications with the information on user's characteristics.

According to another aspect of the present invention, there is provided an application selecting and executing apparatus comprising: an application information analyzer analyzing information on each of a plurality of applications providing a broadcasting service; an application selector selecting an application suitable for a broadcasting receiving apparatus among the plurality of applications based on the analysis; and an application executor executing the selected application wherein the application selector compares information on the broadcasting receiving apparatus that executes the selected application included in the information on each of the plurality of applications with information on the broadcasting receiving apparatus that receives the selected application, if a plurality of applications are determined to be suitable for the broadcasting receiving apparatus that receives the selected application, compares extended information on the characteristics of the broadcasting receiving apparatus capable of executing the selected application included in the information on each of the plurality of applications with information on the characteristics of the broadcasting receiving apparatus that receives the selected application.

According to another aspect of the present invention, there is provided an application selecting and storing apparatus comprising: an application information analyzer analyzing information on each of a plurality of applications providing a broadcasting service; an application selector selecting at least one application suitable for a broadcasting receiving apparatus among the plurality of applications based on the analysis; and an application storage unit storing the at least one selected application.

The application selector may compare information on the broadcasting receiving apparatus capable of executing the corresponding application included in the information on each of the plurality of applications with information on the broadcasting receiving apparatus that receives the selected at least one application.

The application selector may compare the information on the broadcasting receiving apparatus capable of executing the corresponding application included in the information on each of the plurality of applications with information on the broadcasting receiving apparatus that receives the selected at least one application and information on at least one of other broadcasting receiving apparatuses over a network to which the broadcasting receiving apparatus that receives the selected at least one application belongs.

The application selector may compare the information on the broadcasting receiving apparatus capable of executing the corresponding application included in the information on each of the plurality of applications with information on another broadcasting receiving apparatus that requests to store the selected at least one application.

### BRIEF DESCRIPTION OF THE DRAWINGS

The above and other aspects of the present invention will become more apparent by describing in detail exemplary embodiments thereof with reference to the attached drawings, in which:

FIG. 1 is a diagram of a related art illustrating that one application is transmitted to one broadcasting receiving apparatus;

FIG. 2 is a diagram of a related art illustrating that one application is stored in one broadcasting receiving apparatus;

FIG. 3 is a diagram of a system in which a plurality of applications are transmitted to various kinds of broadcasting receiving apparatuses according to an embodiment of the present invention;

FIG. 4 is a flowchart illustrating a method of generating a plurality of applications according to an exemplary embodiment of the present invention;

FIG. 5 is a block diagram of an apparatus for generating a plurality of applications according to an exemplary embodiment of the present invention;

FIG. 6 is a flowchart illustrating a method of selecting and executing an application suitable for a broadcasting receiving apparatus among a plurality of applications according to an exemplary embodiment of the present invention;

FIG. 7 is a block diagram of an apparatus for processing an application suitable for a broadcasting receiving apparatus among a plurality of applications according to an exemplary embodiment of the present invention;

FIG. 8 is a diagram for explaining an application executing method according to an exemplary embodiment of the present invention;

FIG. 9 is a flowchart illustrating a method of selecting and storing an application suitable for a broadcasting receiving apparatus among a plurality of applications according to an exemplary embodiment of the present invention;

FIG. 10 is a block diagram of an apparatus for selecting and storing an application suitable for a broadcasting receiving apparatus among a plurality of applications according to an exemplary embodiment of the present invention;

FIG. 11 is a diagram for explaining a method of selecting and storing an application suitable for a broadcasting receiving apparatus among a plurality of applications according to an exemplary embodiment of the present invention;

FIG. 12 is a diagram for explaining a method of selecting and storing an application suitable for a broadcasting receiving apparatus among a plurality of applications according to another exemplary embodiment of the present invention;

FIG. 13 is a diagram for explaining a method of selecting and storing an application suitable for a broadcasting receiving apparatus among a plurality of applications according to another exemplary embodiment of the present invention;

FIG. 14 is a diagram for explaining a method of executing the application stored in FIG. 13, the method being performed by another broadcasting receiving apparatus according to an exemplary embodiment of the present invention;

FIG. 15 is a flowchart of a method of executing an application suitable for a broadcasting receiving apparatus among a plurality of applications by reflecting user's characteristics according to an exemplary embodiment of the present invention;

FIG. 16 is a diagram for explaining a method of selecting an application based on user's characteristics according to an exemplary embodiment of the present invention;

FIG. 17 is a diagram for explaining a method of selecting an application based on user's characteristics according to another exemplary embodiment of the present invention;

FIG. 18 is a diagram for explaining a method of selecting an application based on user's characteristics according to another exemplary embodiment of the present invention;

FIG. 19 is a flowchart of a method of selecting and executing an application suitable for a broadcasting receiving apparatus among a plurality of applications by reflecting extension information on the broadcasting receiving apparatus according to an exemplary embodiment of the present invention;

FIG. 20 is a diagram for explaining a problem occurred in reproducing a broadcasting service including a plurality of applications according to an exemplary embodiment of the present invention;

FIG. 21 is a diagram for explaining a method of selecting an application by reflecting extended information on a broadcasting receiving apparatus according to an exemplary embodiment of the present invention;

FIG. 22 is a diagram for explaining a method of selecting an application by reflecting extended information on a broadcasting receiving apparatus according to another exemplary embodiment of the present invention;

FIG. 23 is a diagram for explaining a method of selecting an application by reflecting extended information on a broadcasting receiving apparatus according to another exemplary embodiment of the present invention; and

FIG. 24 is a diagram for explaining a method of selecting an application by reflecting extended information on a broadcasting receiving apparatus according to another exemplary embodiment of the present invention.

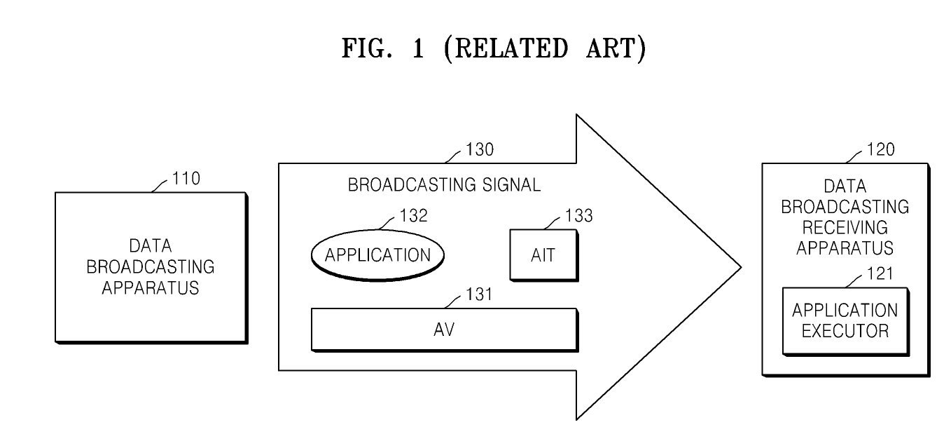

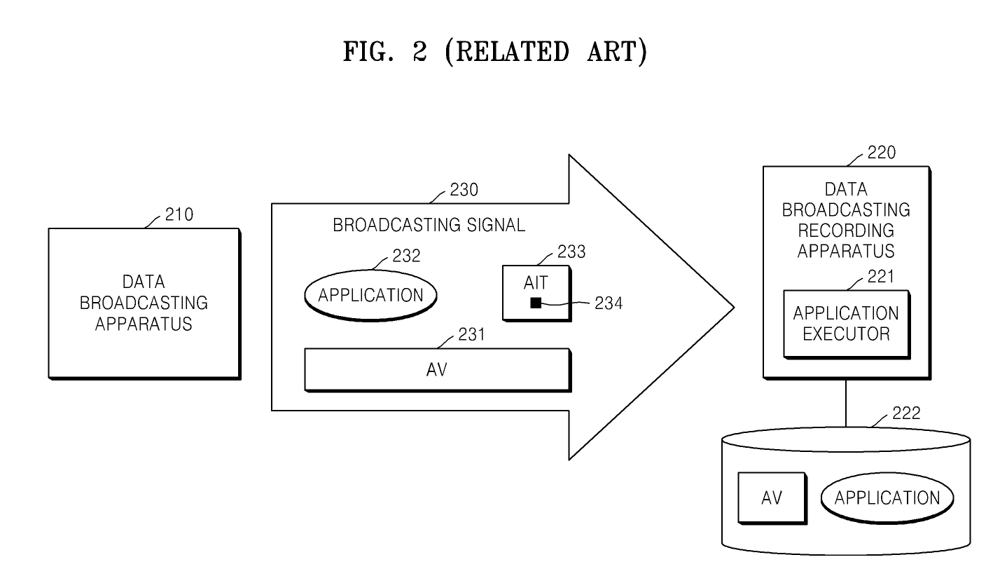

### DETAILED DESCRIPTION OF EXEMPLARY EMBODIMENTS

The present invention will now be described more fully with reference to the accompanying drawings.

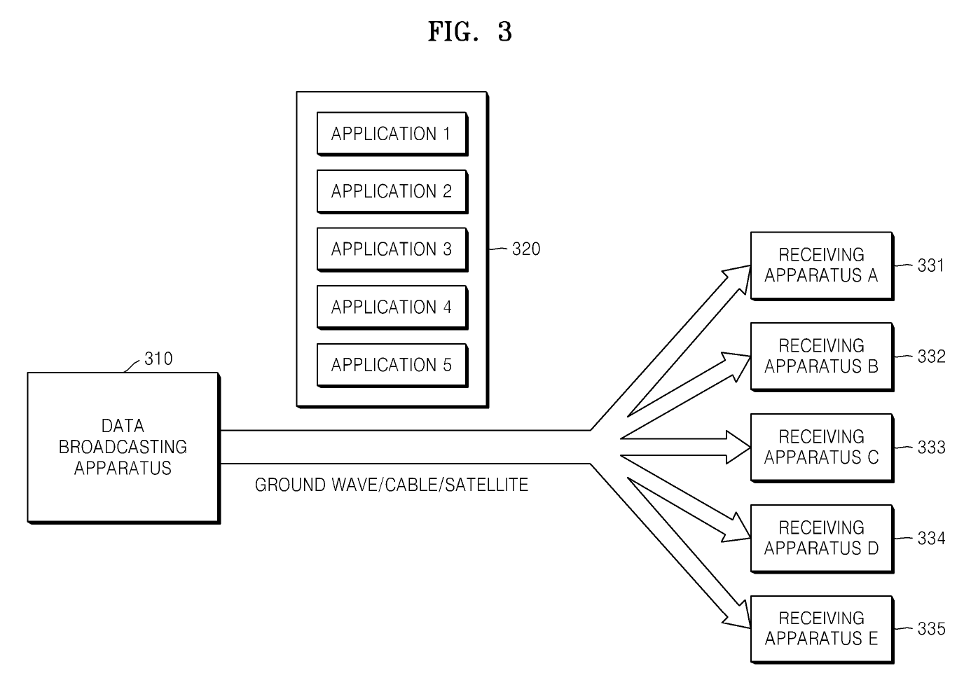

FIG. 3 is a diagram of a system in which a plurality of applications 320 are transmitted to various kinds of broadcasting receiving apparatuses according to an exemplary embodiment of the present invention. Referring to FIG. 3, a data broadcasting apparatus 310 generates the plurality of applications having different functions according to kinds of broadcasting receiving apparatuses. Although the plurality of applications 320 have a common object, they are selectively executed by broadcasting receiving apparatuses having different additional functions. In detail, the plurality of applications 320 have different properties, and must be selectively executed by broadcasting receiving apparatuses. The number of applications transmitted to broadcasting receiving apparatuses is not limited, and can be determined according to kinds or specification of broadcasting receiving apparatuses.

The plurality of applications 320 include application 1, application 2, application 3, application 4, and application 5. It is assumed that the plurality of applications 320 have a common object to provide a sports game.

The application 1 provides the sports game and additional information such as information on football players, game progress, etc. The application 2 provides a football game photographed at a different angle through another channel when the sports game is provided. The another channel may be a channel having a physically same frequency, or another logical channel included in a physical channel such as a multi mode service (MMS).

The application 3 provides a function of recording football game broadcasting while providing the football game. The application 4 provides the football game and a video clip including an interview of football players. The video clip may be information received through a broadcasting channel or information recorded in a receiving terminal. Although the application 5 is identical to the application 1, it provides a graphic user interface (GUI) for a small screen.

Receiving terminal A 331 through receiving terminal E 335 are televisions having a function of displaying received broadcasting but have different specifications. The receiving terminal A 331 is a large television providing broadcasting received through a tuner on a large screen. The receiving terminal B 332 is a television having two tuners and providing a picture in picture (PIP) function of providing two broadcasting received through two channels. The receiving terminal C 333 is a television having a recording function. The receiving terminal D 334 is a television having a function of decoding two pieces of video data. The receiving terminal E 335 is a small television providing received broadcasting on a small screen.

Although the plurality of applications 320 are simultaneously transmitted through a predetermined broadcasting channel, each receiving terminal executes a different application. It is suitable to execute the application 1 in the receiving terminal A 331. It is suitable to execute the application 2 in the receiving terminal B 332. It is suitable to execute the application 3 in the receiving terminal C 333. It is suitable to execute the application 4 in the receiving terminal D 334. It is suitable to execute the application 5 in the receiving terminal E 335.

Therefore, in an environment where the plurality of applications 320 are transmitted, each receiving terminal selects an application easily executed among the plurality of applications 220 to execute the selected application.

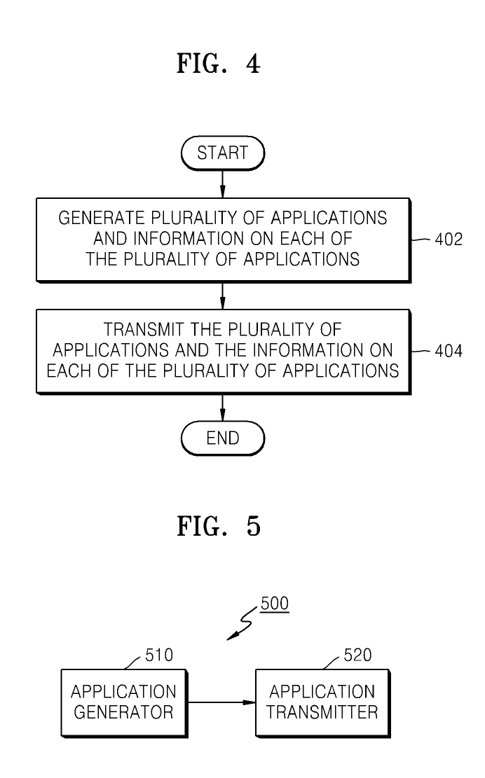

FIG. 4 is a flowchart illustrating a method of generating a plurality of applications according to an exemplary embodiment of the present invention. Referring to FIG. 4, the plurality of applications and information on each of the plurality of applications are generated in operation 402. As mentioned above, the plurality of applications provide a common broadcasting service and an additional function selectively executed by a broadcasting receiving apparatus. The information on each of the plurality of applications may be transmitted in an application information table (AIT) or an extended application information table (XAIT). The AIT includes overall information on a broadcasting service, information on an application transmitted through broadcasting, etc.

The information on each of the plurality of applications according to the current exemplary embodiment of the present invention includes information on the broadcasting receiving apparatus that may execute the plurality of applications, respectively. For example, the information on the broadcasting receiving apparatus includes at least one of identification information and version information on the broadcasting receiving apparatus. The AIT can include information on an application with respect to a broadcasting receiving terminal A to information on an application with respect to a broadcasting receiving terminal N, where N is a natural number.

The information on each of the plurality of applications can be defined based on a function performed by the broadcasting receiving apparatus. For example, the AIT can include information on an application with respect to a function A to information on an application with respect to a function N, where N is a natural number.

An AIT corresponding to each of the plurality of applications is transmitted to provide the information on each of the plurality of applications according to a broadcasting receiving apparatus or a function. The information on each of the plurality of applications can have a variety of forms.

The plurality of applications and the information on each of the plurality of applications are transmitted in operation 404 via a ground wave, an Internet network, or satellite.

FIG. 5 is a block diagram of an apparatus 400 for generating a plurality of applications according to an exemplary embodiment of the present invention. Referring to FIG. 5, the apparatus 500 for generating a plurality of applications comprises an application generator 510 and an application transmitter 520.

The application generator 510 generates the plurality of applications which provides a common broadcasting service and is selectively executed by a broadcasting receiving apparatus, and information on each of the plurality of applications. The information on each of the plurality of applications may include information on a corresponding broadcasting receiving apparatus that executes the plurality of applications, respectively. For example, the information on the broadcasting receiving apparatus includes at least one of identification information and version information on the broadcasting receiving apparatus. The application on each of the plurality of applications can be defined based on a function performed by the broadcasting receiving apparatus.

The application transmitter 520 transmits the plurality of applications and the information on each of the plurality of applications. The application transmitter 520 generates a transmission stream for transmitting the plurality of applications and the information on each of the plurality of applications, and transmits the transmission stream using a carousel method suitable for broadcasting.

For example, the application transmitter 520 generates the plurality of applications and the information on each of the plurality of applications in the form of an MPEG-2 transmission stream, sequentially converts the MPEG-2 transmission stream into an object carousel, a data carousel, and a MPEG-2 digital storage media command and control (DSM-CC) message, and broadcasts the DSM-CC message.

The DSM-CC is the standard technology defined by the International Organization for Standardization/International Electrotechnical Commission (ISO/IEC) 13818-6 and indicates a transport layer message for a data service. The ISO/IEC 13818-6 is the MPEG standard technology relating to a carousel structure and transmission method. The data carousel is a mechanism for a periodic transmission of a data module defined by a DSM-CC user-to-network download protocol. The object carousel is a mechanism for a periodic transmission of a DSM-CC user-to-user (U-U) object above the data carousel, and carries a layer file structure using a DSM-CC U-U file/directory object.

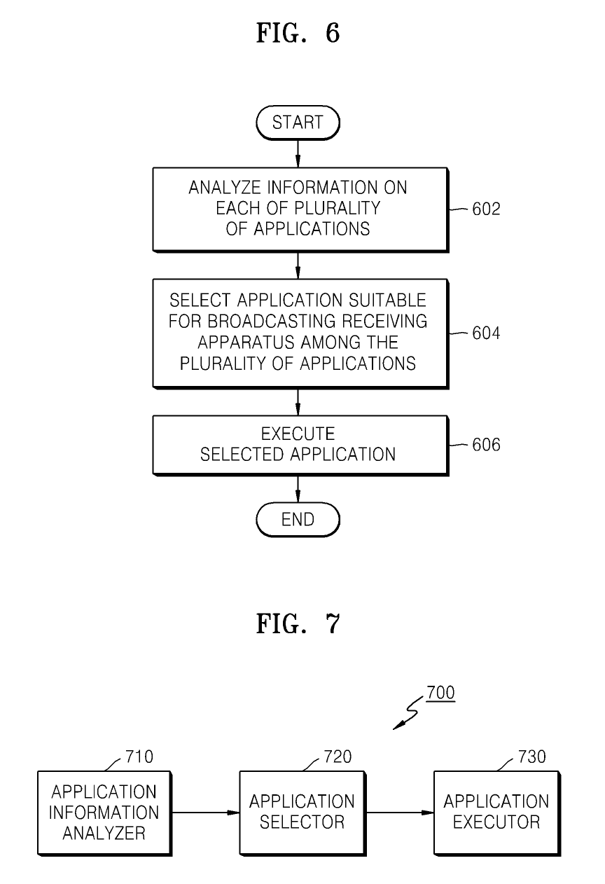

FIG. 6 is a flowchart illustrating a method of selecting and executing an application suitable for a broadcasting receiving apparatus among a plurality of applications, according to an exemplary embodiment of the present invention. Referring to FIG. 6, information on each of the plurality of applications providing a common broadcasting service is analyzed in operation 602.

The application suitable for the broadcasting receiving apparatus is selected among the plurality of applications based on the analysis in operation 604.

In operation 604, information on the broadcasting receiving apparatus that executes the plurality of applications included in the information on each of the plurality of applications is compared with information on the broadcasting receiving apparatus that receives the plurality of applications to select a matching application. Or, in operation 604, information on a function performed by the broadcasting receiving apparatus included in the information on each of the plurality of applications is compared with information on a function performed by the broadcasting receiving apparatus that receives the plurality of applications to select the matching application.

The selected application is executed in operation 606.

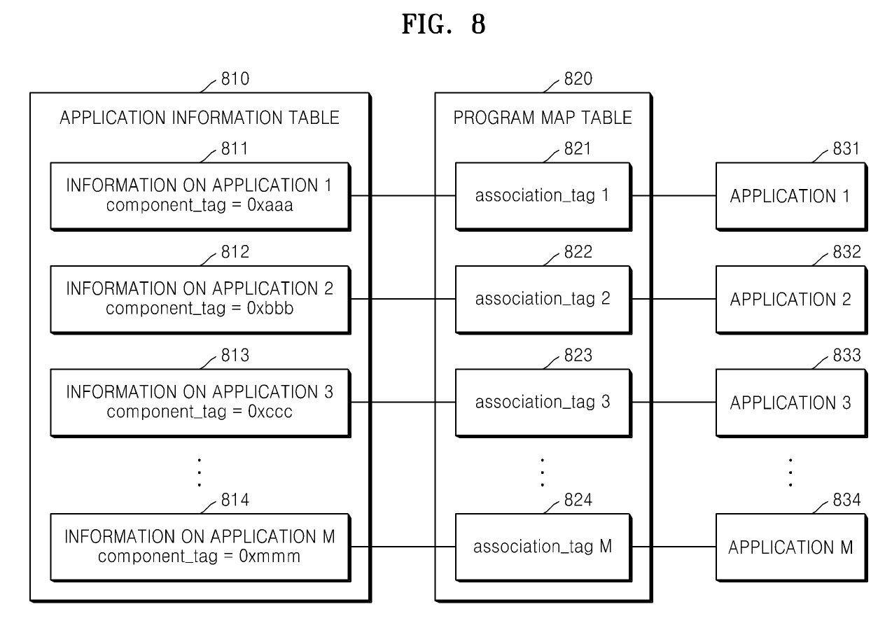

FIG. 8 is a diagram for explaining an application executing method according to an exemplary embodiment of the present invention. Referring to FIG. 8, information on each of a plurality of applications 811-814 included in an application information table 810 is transmitted. The information on each of a plurality of applications 811-814 includes a component tag for identifying a basic service component transferring each of the plurality of applications. The identified service component is a stream for transferring information on an object carousel. Association tags 821-824 describing carousel information are included in a program map table 820 in the stream. Each of the plurality of applications 831-834 can be retrieved from streams linked with the association tags 821-824. Therefore, in operation 606 illustrated in FIG. 6, the selected application is acquired and executed using the component tag which is information on a carousel included in the information on each of the plurality of applications and the association tags 821-824 which are information on the carousel included in the program map table 820 of the stream including the selected application.

FIG. 7 is a block diagram of an apparatus 700 for executing an application suitable for a broadcasting receiving apparatus among a plurality of applications according to an exemplary embodiment of the present invention. Referring to FIG. 7, the apparatus 700 for processing the application comprises an application information analyzer 710, an application selector 720, and an application executor 730.

The application information analyzer 710 analyzes information on each of the plurality of applications providing a common broadcasting service.

The application selector 720 selects an application suitable for the broadcasting receiving apparatus among the plurality of applications based on the analysis. The application selector 720 compares information on the broadcasting receiving apparatus that executes the plurality of applications, respectively, included in the information on each of the plurality of applications, with information on the broadcasting receiving apparatus that receives the plurality of applications to select a matching application. The broadcasting receiving apparatus stores identification information identified by another apparatus and version information, and communicates with the apparatus 700 for processing the application to provide the identification information and the version information.

Or, the application selector 720 compares information on a function performed by the broadcasting receiving apparatus included in the information on each of the plurality of applications with information on a function performed by the broadcasting receiving apparatus that receives the plurality of applications to select the matching application.

The application executor 730 executes an application included in a transmission stream described by the information on each of the plurality of applications. The application executor 730 acquires the selected application and executes the acquired application using a component tag which is information on a carousel included in the information on each of the plurality of applications, and an association tag which is information on the carousel included in a program map table of a stream including the selected application.

The apparatus 700 for processing the application can be included in a data broadcasting receiving apparatus. Although the data broadcasting receiving apparatus including the apparatus 700 for processing the application receives the plurality of applications providing a common broadcasting service, it can select an application easily executed and execute the selected application. Or, the apparatus 700 for processing the application communicates with the data broadcasting receiving apparatus through a predetermined interface so that an application easily executed by the data broadcasting receiving apparatus can be selected.

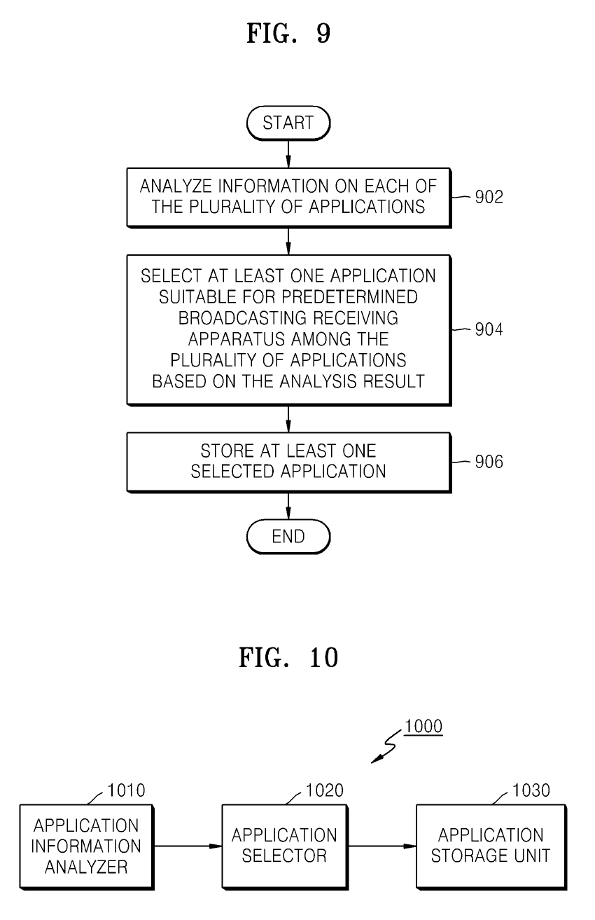

FIG. 9 is a flowchart illustrating a method of selecting and storing an application suitable for a broadcasting receiving apparatus among a plurality of applications according to an exemplary embodiment of the present invention. Referring to FIG. 9, when the plurality of applications produced according to the characteristics of the broadcasting receiving apparatus including an application recording descriptor are signaled, if a user instructs to record a broadcasting service, it is possible to record all applications including the application recording descriptor. Alternatively, an application that satisfies the characteristics of the broadcasting receiving apparatus, i.e., an application that is selected according to analysis of information on each of the plurality of applications, can be recorded. Alternatively, an application suitable for the characteristics of another receiving apparatus of the same home network and for the broadcasting receiving apparatus as well can be recorded. Hereinafter, for descriptive convenience, although a network type is limited to a home network, it is obvious that the technical feature of the present invention can be applied to another type of a network.

When a broadcasting service provider wants to record all applications including the application recording descriptor, if a flag that unconditionally instructs to record an application is established in the application recording descriptor and is signaled, the receiving apparatus can record the application prior to information on the receiving apparatus included in the information on each of the plurality of applications. In more detail, if the recording flag is unconditionally established in the application recording descriptor, the receiving apparatus can record even an application that does not satisfy identification information or other characteristics thereof.

Information on each of the plurality of applications corresponding to each of the plurality of application is analyzed in order to provide a broadcasting service in operation 902. At least one application is selected suitable for a predetermined broadcasting receiving apparatus among the plurality of applications that are signaled based on an analysis result in operation 904. Information included in the information on each of the plurality of applications is compared to information on the broadcasting receiving apparatus that directly receives the applications to select a matching application. Further, information on another broadcasting receiving apparatus of a home network, which the broadcasting receiving apparatus belongs to, is compared to the information on each of the plurality of applications to record even an application for the another broadcasting receiving apparatus. Alternatively, the information on another broadcasting receiving apparatus of the home network is compared to the information on each of the plurality of applications, thereby providing a recording service for the broadcasting receiving apparatus other than another broadcasting receiving apparatus. Alternatively, an application suitable for another receiving apparatus that requests the broadcasting receiving apparatus to store the application can be stored. The selected application(s) is stored along with AV data stream in operation 906.

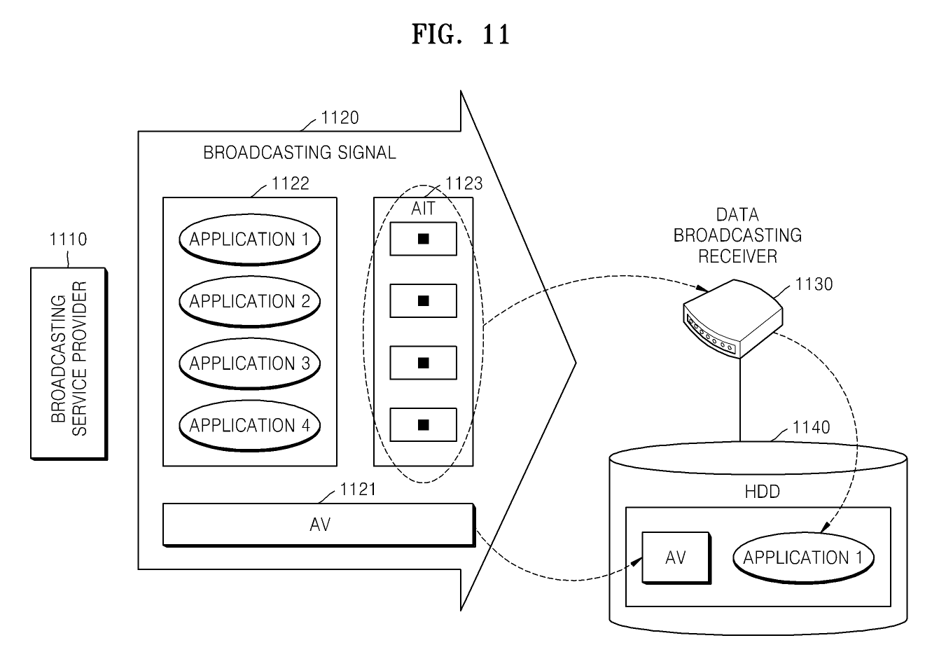

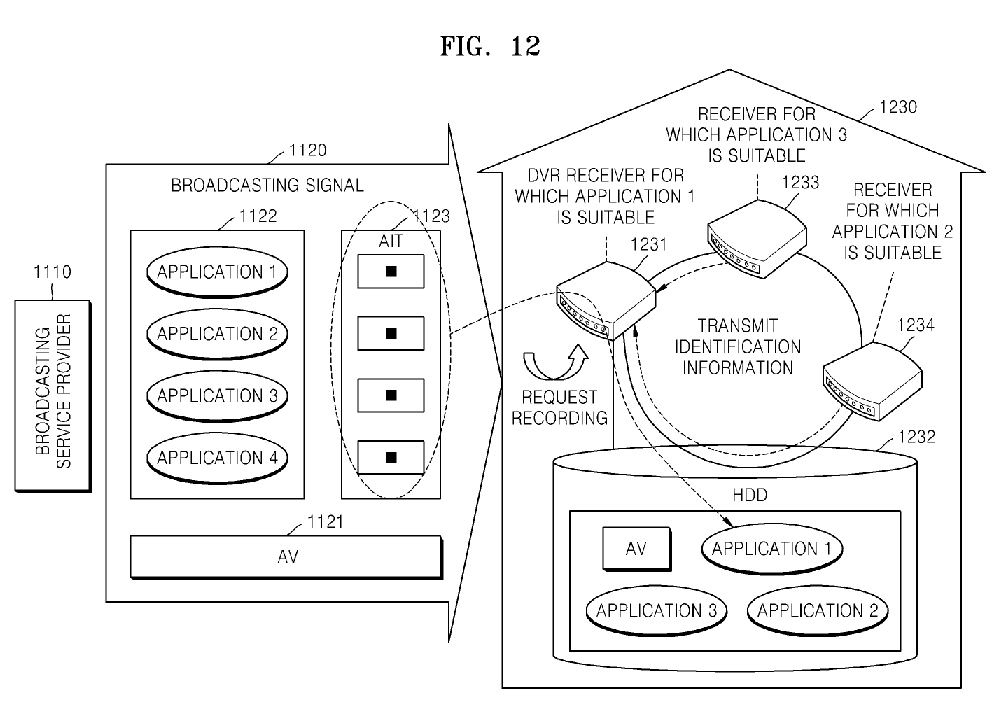

FIG. 10 is a block diagram of an apparatus 1000 for selecting and storing an application suitable for a broadcasting receiving apparatus among a plurality of applications according to an exemplary embodiment of the present invention. Referring to FIG. 10, an application information analyzer 1010 analyzes information on each of the plurality of applications corresponding to each of the plurality of applications. If an application selector 1020 selects the application to be stored from the plurality of applications as described with reference to FIG. 9, an application storage unit 1030 stores the selected application in a storage medium (not shown) included in the apparatus 1000 for selecting and storing the application. The selection of the application to be stored will now be described in more detail with reference to FIGS. 11 through 14.

FIG. 11 is a diagram for explaining a method of selecting and storing an application suitable for a broadcasting receiving apparatus among a plurality of applications according to an exemplary embodiment of the present invention. Referring to FIG. 11, a broadcasting service provider 1110 transmits a broadcasting signal 1121 which includes an AV data stream 1121 and four applications 1 through 4 1122. The AIT 1123 corresponding to each of the applications 1 through 4 1122 includes an application recording descriptor that instructs to record the applications 1 through 4 1122. A data broadcasting receiver 1130 selects the application 1 satisfying the characteristics thereof and stores the application 1 and AV data in a hard disk 1140.

When the data broadcasting receiver 1130 having a function of a digital video recorder (DVR) for actually receiving and recording broadcasting records an application satisfying the characteristics thereof, if another data broadcasting receiver of a home network requests the data broadcasting receiver 1130 having the DVR function to reproduce the recorded application, it is a problem that the data broadcasting receiver 1130 can reproduce only the AV data except the application.

FIG. 12 is a diagram for explaining a method of selecting and storing an application suitable for a broadcasting receiving apparatus among a plurality of applications according to another exemplary embodiment of the present invention. Referring to FIG. 12, when a receiver 1231 proceeds with recording by a user's input, the receiver 1231 records AV data and all application that can be executed by each receiver according to the characteristics of other receivers 1233 and 1234 of a home network 1230. In this case, the receivers 1231, 1233, and 1234 must share their existence and identification information. It is obvious of those of ordinary skill that various routine methods can be used to detect the existence of other receivers of a network. After the existence of the other receivers 1233 and 1234 is detected, the identification information on each of the receivers 1233 and 1234 is transmitted to the receiver 1231. The receiver 1231 compares identification information thereof and the identification information on the other receivers 1233 and 1234 to information on each of the plurality of applications included in an AIT 1123, and stores applications 1, 2, and 3 suitable for each of the receivers 1231, 1233, and 1234 in a hard disk 1232 thereof. Therefore, the other receivers 1233 and 1234 access the receiver 1231 to use the suitable applications 2 and 3 and their recordings.

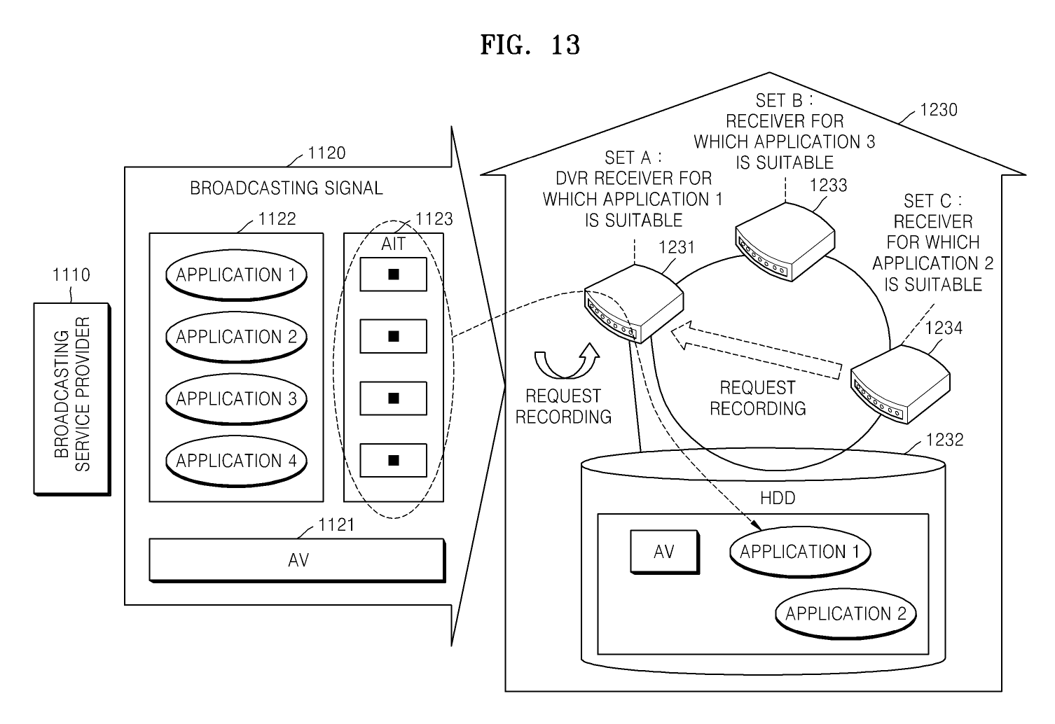

FIG. 13 is a diagram for explaining a method of selecting and storing an application suitable for a broadcasting receiving apparatus among a plurality of applications according to another exemplary embodiment of the present invention. Referring to FIG. 13, when a receiver 1234 that operates as a remote client of a home network 1230 requests a receiver 1231 having a function of a DVR to record an application, the receiver 1231 selects an application 2 satisfying the characteristics information of the receiver 1234 and stores the application 2. The receiver 1231 may store an application 1 suitable for the receiver 1231.

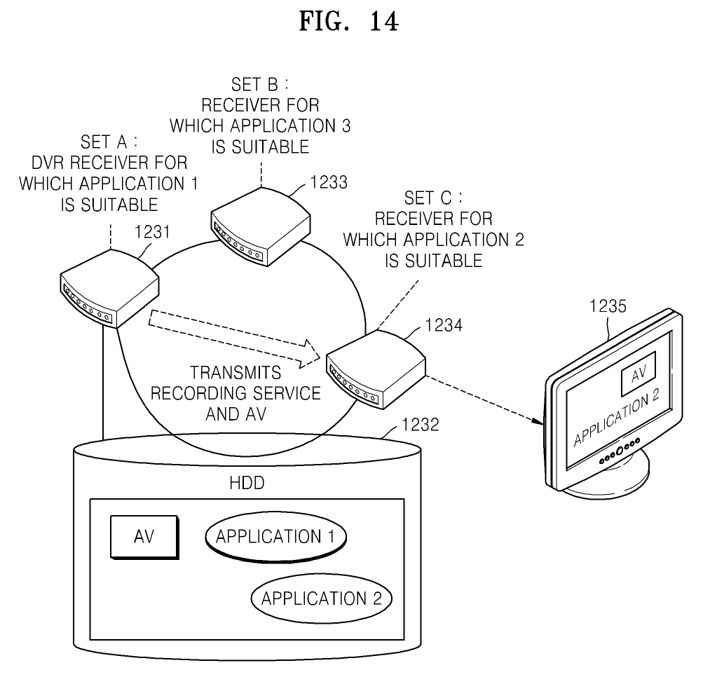

FIG. 14 is a diagram for explaining a method of executing the application stored in FIG. 13, the method being performed by another broadcasting receiving apparatus 1234 according to an exemplary embodiment of the present invention. Referring to FIG. 14, when the broadcasting receiving apparatus 1234 of a home network remotely accesses the stored application and reproduces the stored application, since the broadcasting receiving apparatus 1234 can select an application 2 suitable for the broadcasting receiving apparatus 1234 and execute the application 2, it is possible to normally reproduce the stored application and the application 2 on a display 1235.

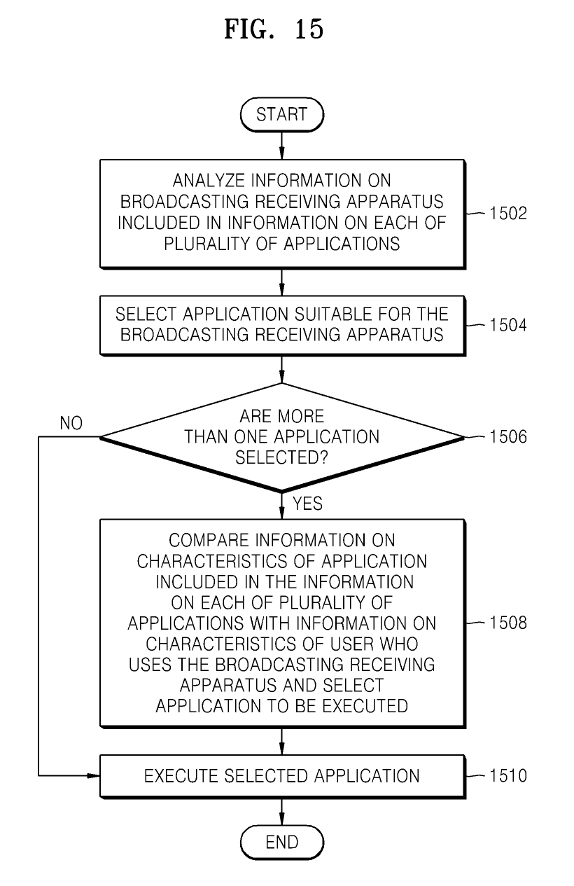

FIG. 15 is a flowchart of a method of executing an application suitable for a broadcasting receiving apparatus among a plurality of applications by reflecting a user's characteristics according to an exemplary embodiment of the present invention, and more particularly, a method of selecting an application from a plurality of applications satisfying the characteristics of a broadcasting receiving apparatus.

Referring to FIG. 15, information on the broadcasting receiving apparatus included in information on each of the plurality of applications is analyzed in operation 1502. An application suitable for the broadcasting receiving apparatus is selected based on the analysis in operation 1504. If one application is selected, the selected application is executed in operation 1510. However, if more than one application is selected in operation 1506, an application to be executed according to the user's characteristics is selected in operation 1508. Information on the user's characteristics may be previously stored in the broadcasting receiving apparatus or may be input by a user. In the present exemplary embodiment, information on each of the plurality of applications includes information on the characteristics of an application that corresponds to the information on the user's characteristics. The information on the user's characteristics is compared to the information on the characteristics of the application obtained by analyzing the information on each of the plurality of applications, and a matching application is finally selected based on the comparison result and executed in operation 1510.

The information on the user's characteristics may comprise a user's favorite application style, a user's rank, a user's favorite first language, and/or a user's age, etc. The information on the characteristics of the application may comprise a style of the application, a user's rank having a right to use the application, information on a language used to describe the application and/or a user's proper age to use the application, etc. The information on the user's characteristics is not limited thereto but may comprise a user's favorite type of an electronic program guide (EPG), a user's favorite second language, whether a user prefers a text-based application or a graphic-based application, and information on other users' interests. Likewise, the corresponding information is signaled as the information on each of the plurality of applications and is compared to the user's characteristics when the application is selected.

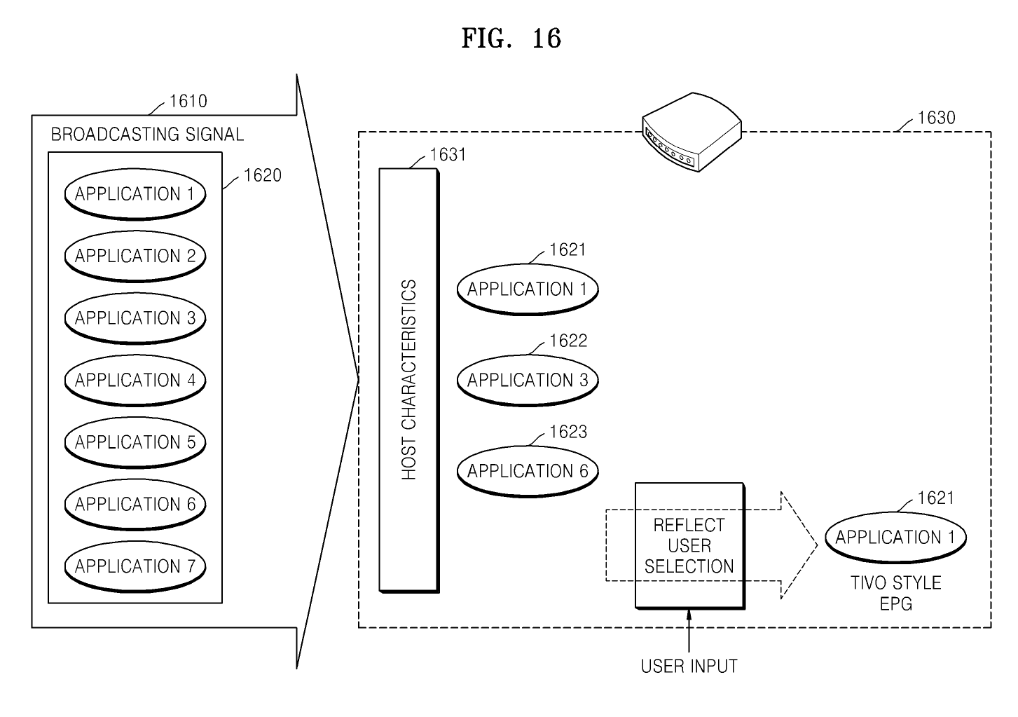

User identification information used to present the user's characteristics is designated via a multiple system operator (MSO) or a broadcasting station. A matter selected by the user is confirmed in the broadcasting receiving apparatus through an application having a right to cache the user identification information on flash such as a monitor application or storage. Thereafter, the matter selected by the user is cached as information that can be read and processed by the broadcasting receiving apparatus and utilized. Alternatively, as will be described with reference to FIG. 16, among the plurality of applications, it will be established based on content manually selected by a user from a plurality of applications.

FIG. 16 is a diagram for explaining a method of selecting an application based on a user's characteristics according to an exemplary embodiment of the present invention. Referring to FIG. 16, a broadcasting signal 1610 includes various EPG applications 1620. As a result of selecting an application according to host characteristics 1631 of a broadcasting receiving apparatus 1630, it is determined that an application 1 1621 that is a Tivo style EPG application, an application 3 1622 that is a TV guide style EPG application, and an application 6 1623 that is another style EPG application are suitable. A user's input is received, a user's selection is reflected, and thus the application 1 1621 that is the Tivo style EPG application is selected from the applications 1621 through 1623.

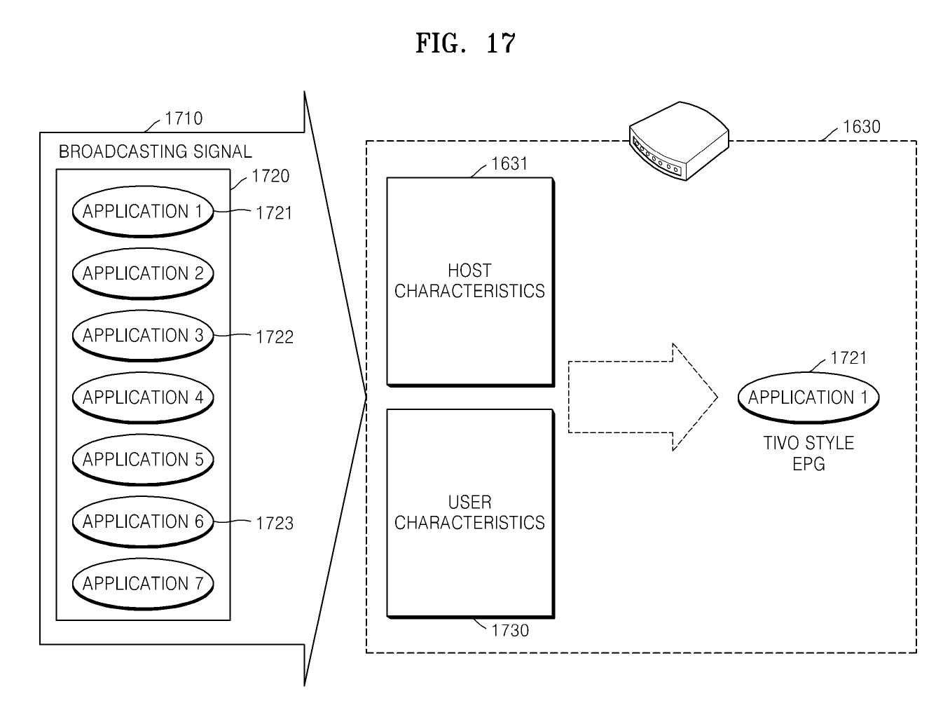

FIG. 17 is a diagram for explaining a method of selecting an application based on a user's characteristics according to another exemplary embodiment of the present invention.

If it is determined that a user prefers the Tivo style EPG by a user's input as described in FIG. 16, information on a user's favorite is stored and used later as information on a user's characteristics. Referring to FIG. 17, a broadcasting signal 1710 includes seven applications 1720. Even though a plurality of applications including an application according to host characteristics 1631 of a broadcasting receiving apparatus 1630 is transmitted, it is determined that an application 1 1721 that is a Tivo style EPG application, an application 3 1722 that is a TV guide style EPG application, and an application 6 1723 that is other style EPG application are selected according to host characteristics 1631, a user's characteristics 1730 are automatically reflected and thus the application 1 1721 that is the Tivo style EPG application is selected without being separately selected by a user.

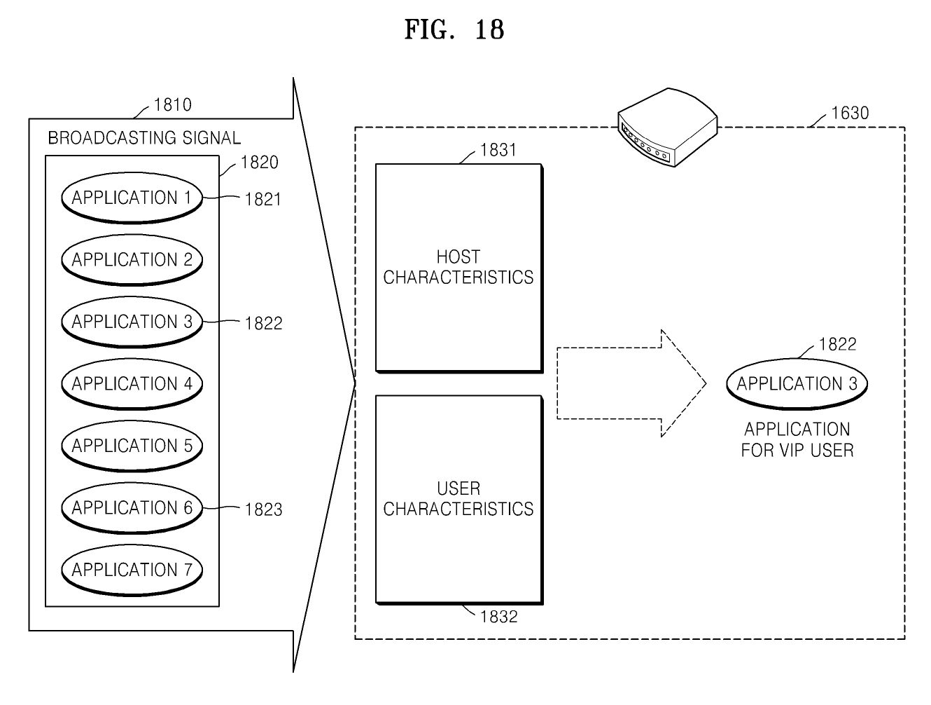

FIG. 18 is a diagram for explaining a method of selecting an application based on a user's characteristics according to another exemplary embodiment of the present invention.

When or after a user subscribes a broadcasting service, a user's rank is determined and thus an application is provided according to the user's rank. Referring to FIG. 18, a plurality of applications including an application 1 1821, an application 3 1822, and an application 6 1823 are selected according to host characteristics 1831 are selected from seven application 1820 included in a broadcasting signal 1810. The selected applications are an application for a general user, an application for a VIP user, and an application for a premium user. The application 3 1822 for the VIP user is selected according to the user's rank.

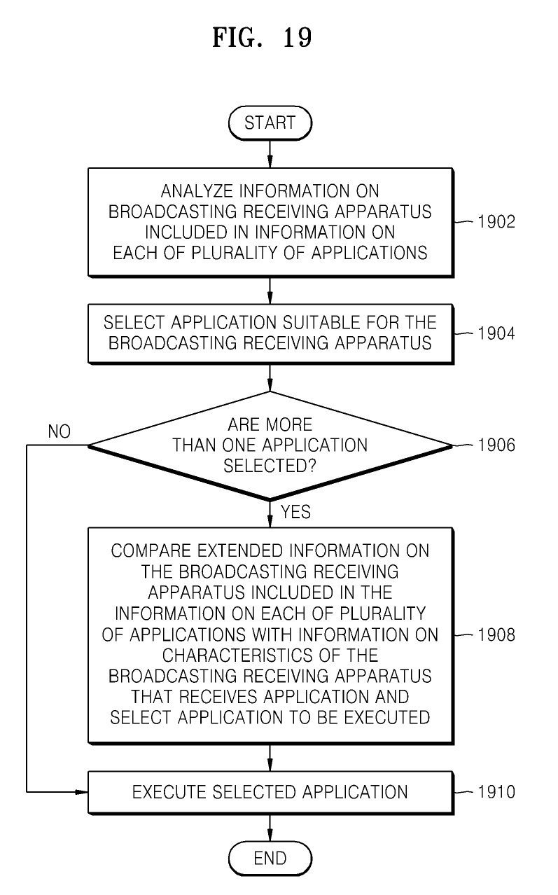

FIG. 19 is a flowchart of a method of selecting and executing an application suitable for a broadcasting receiving apparatus among a plurality of applications by reflecting extension information on the broadcasting receiving apparatus according to an exemplary embodiment of the present invention. The method is another example for determining an application to be executed when a plurality of applications satisfying the characteristics of the broadcasting receiving apparatus are selected.

Referring to FIG. 19, information on the broadcasting receiving apparatus included in information on each of the plurality of applications is analyzed in operation 1902. If a plurality of applications is selected according to identification information or version information that is the basic characteristics of the broadcasting receiving apparatus based on the analysis result in operations 1904 and 1906, an application to be executed can be selected according to other hardware characteristics, i.e., extended information in operations 1908. The broadcasting receiving apparatus includes extended information for specifically determining the characteristics thereof. Application signaling information includes the extended information of the broadcasting receiving apparatus capable of executing a corresponding application and thus both pieces of information are compared to each other.

The extended information may include the number of tuners that is the lower characteristics of a DVR, the number of simultaneous reproductions, the number of simultaneous recordings, the number and size of storage media, whether to support a multi-screen manager system (MSM) belonging to the characteristics of the MSM such as a picture out picture (POP) or a picture in picture (PIP) and the number of multi-screens, a type of an input device that is the characteristics of the input device, graphic resolution and color characteristics that are the graphic characteristics, and the like. Types of the input device are a key type, a point type, a void type, a touch screen type, a type of another advanced input method, or the like. Graphic resolutions are 960×540, 640×480, 320×240, or the like. The color characteristics are color depth or the like. Extended information is not limited thereto. The selection of an application may be based on the extended information of a plurality of items.

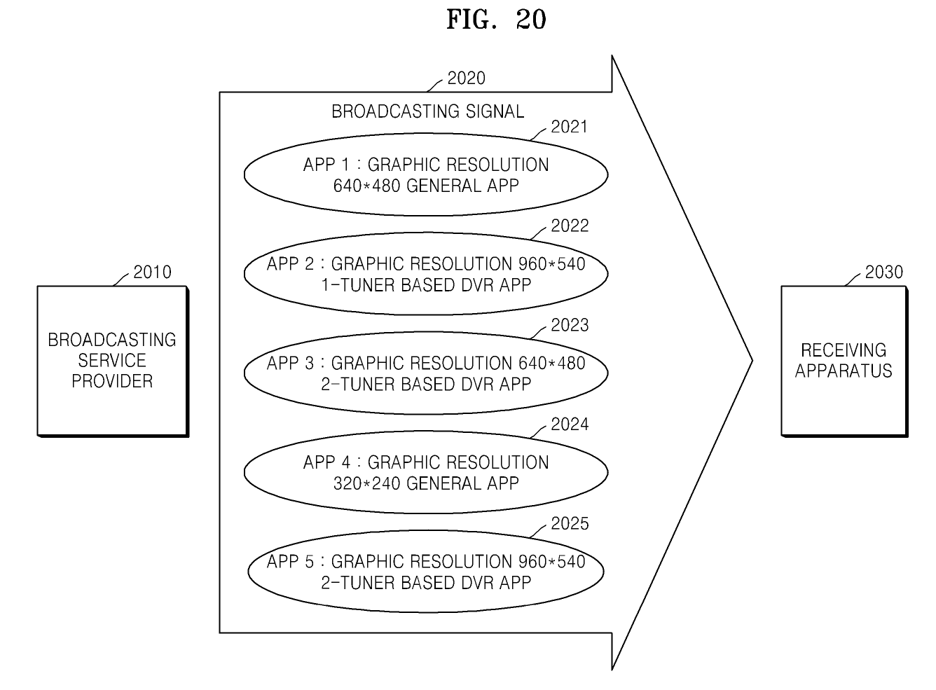

FIG. 20 is a diagram for explaining a problem occurred in reproducing a broadcasting service including a plurality of applications according to an exemplary embodiment of the present invention. Referring to FIG. 20, a broadcasting service provider 2010 signals applications 2021 through 2025 having various pieces of extended information included in a broadcasting signal 2020. If a broadcasting receiving apparatus 2030 is a system supporting a DVR, three DVR applications 2022, 2023, and 2025 are selected based on the basic characteristics including identification information of the broadcasting receiving apparatus 2030. In this case, a more specific determination reference, e.g., extended information of the broadcasting receiving apparatus 2030, is needed to execute which one of the selected DVR applications 2022, 2023, and 2024.

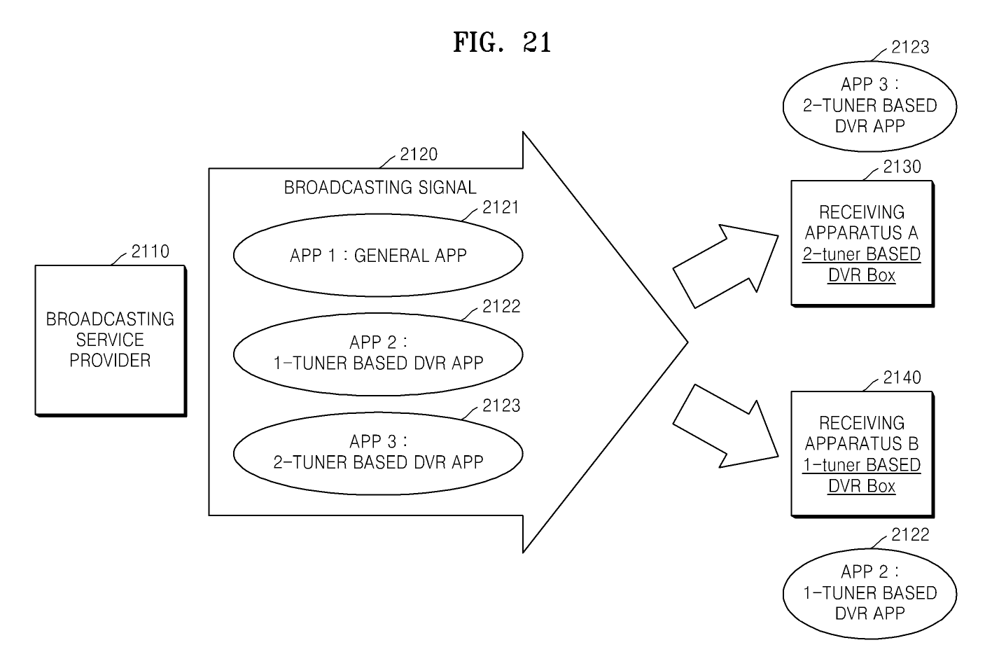

FIG. 21 is a diagram for explaining a method of selecting an application by reflecting extended information on a broadcasting receiving apparatus according to another exemplary embodiment of the present invention. In the present exemplary embodiment, the number of tuners is reflected. Referring to FIG. 21, a broadcasting service provider 2110 transmits a broadcasting signal 2120 including a general application 2121, one tuner based DVR application 2122, and two tuners based DVR application 2123. A broadcasting receiving apparatus A 2130 that is a two tuners based DVR box selects an application 3 2123 matching identification information that is a DVR system and extended information that is a two tuners based system. A broadcasting receiving apparatus B 2140 that is a one tuner based DVR box selects an application 2 2122 matching identification information that is a DVR system and extended information that is a one tuner based system.

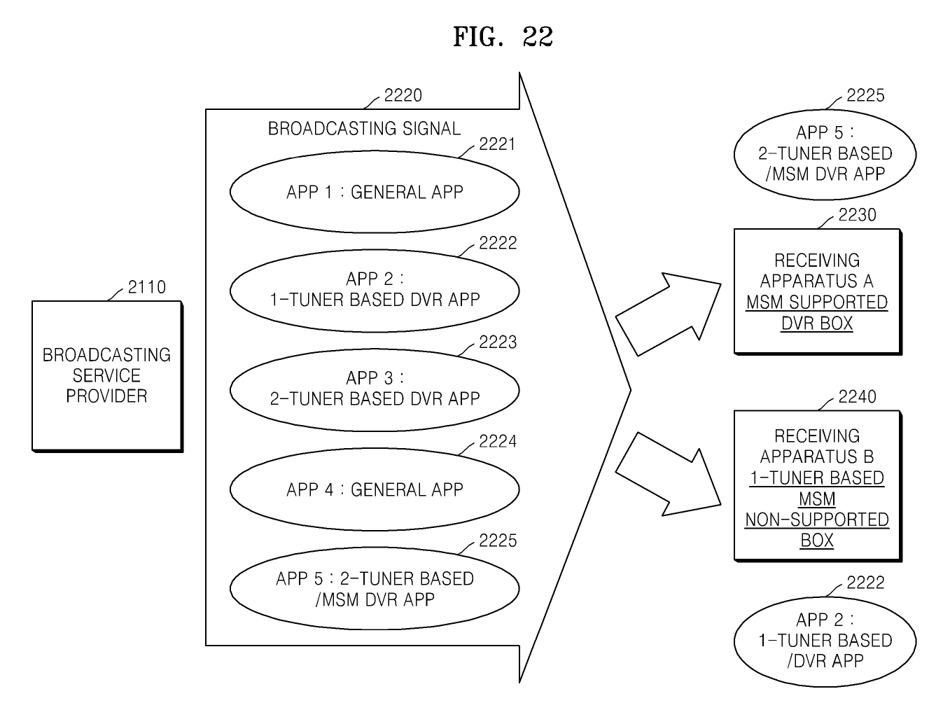

FIG. 22 is a diagram for explaining a method of selecting an application by reflecting extended information on a broadcasting receiving apparatus according to another exemplary embodiment of the present invention. In the present exemplary embodiment, the number of tuners and whether to use an MSM are reflected.

Referring to FIG. 22, five applications 2221 through 2225 are included in a broadcasting signal 2220. A broadcasting receiving apparatus A 2230 selects an application 5 2225 that is a two tuners based MSM DVR application according to identification information and extended information thereof. A broadcasting receiving apparatus B 2240 selects an application 2 2222 that is a one tuner based DVR application.

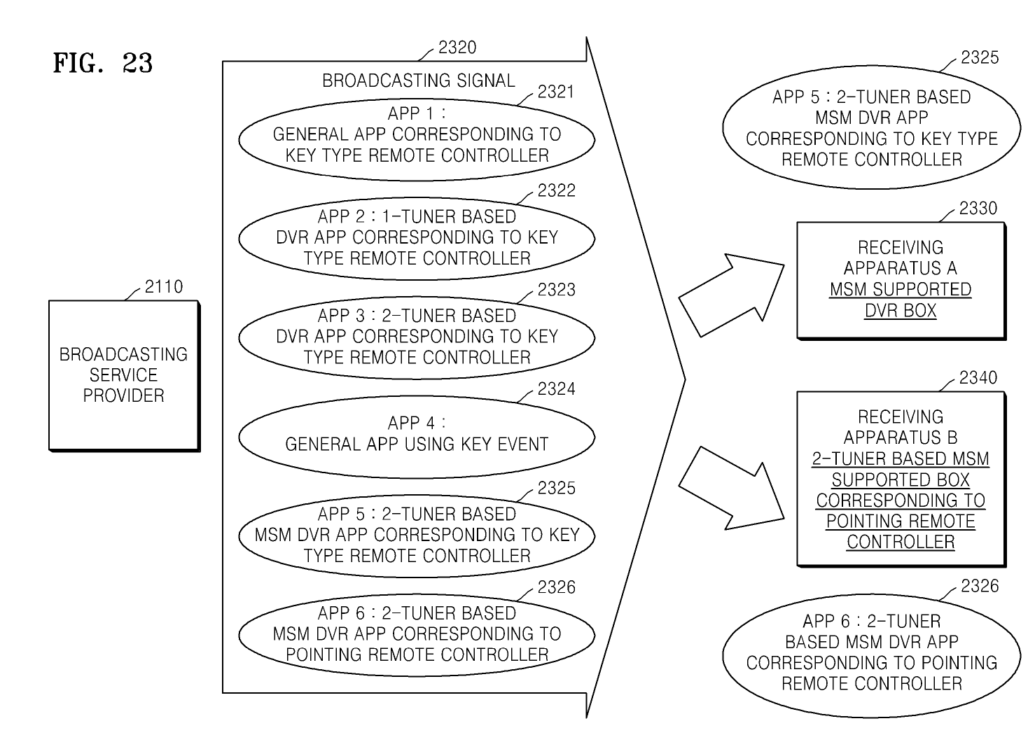

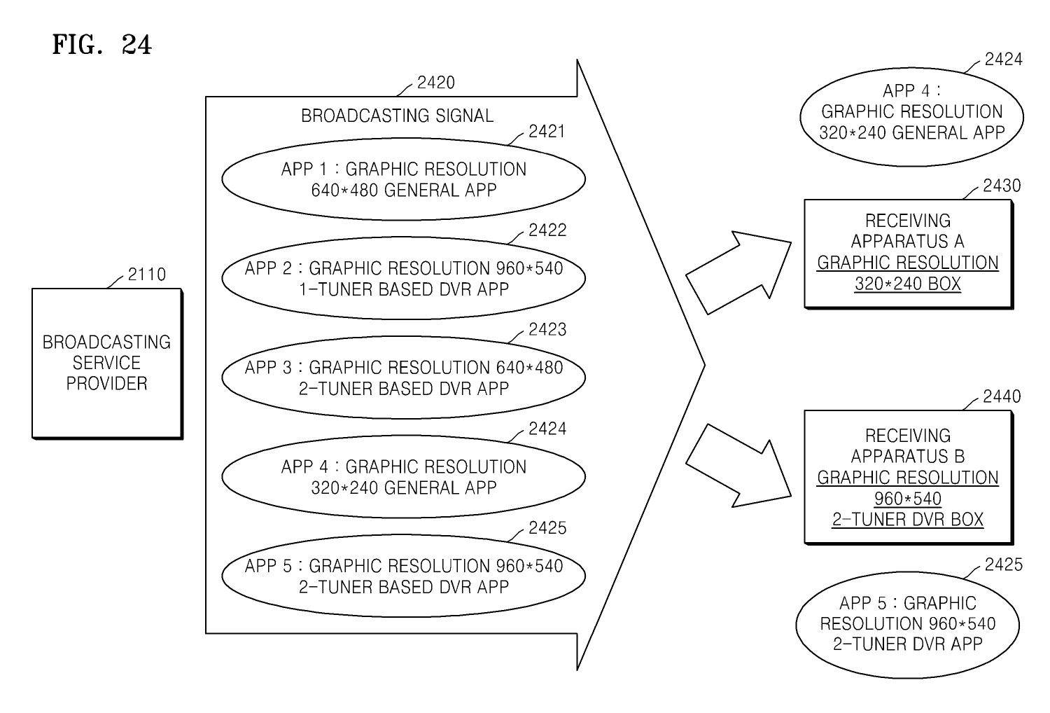

FIG. 23 is a diagram for explaining a method of selecting an application by reflecting extended information on a broadcasting receiving apparatus according to another exemplary embodiment of the present invention. In the present exemplary embodiment, the number of tuners, whether to support an MSM, and a type of an input device are reflected.

Referring to FIG. 23, six applications 2321 through 2326 having various characteristics are included in a broadcasting signal 2320. A broadcasting receiving apparatus A 2330 selects an application 5 2325 according to identification information and extended information thereof. A broadcasting receiving apparatus B 2340 selects an application 6 2326.

FIG. 24 is a diagram for explaining a method of selecting an application by reflecting extended information on a broadcasting receiving apparatus according to another exemplary embodiment of the present invention. In the present exemplary embodiment, the number tuners and the graphic characteristics are reflected.

Referring to FIG. 24, five applications 2421 through 2425 having various characteristics are included in a broadcasting signal 2420. A broadcasting receiving apparatus A 2430 selects an application 4 2424 according to identification information and extended information thereof. A broadcasting receiving apparatus B 2440 selects an application 5 2425.

The present invention can also be embodied as computer readable code on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, and optical data storage devices. The computer readable recording medium can also be distributed network coupled computer systems so that the computer readable code is stored and executed in a distributed fashion.

The present invention provides an application generating and signaling method and apparatus that transmit a plurality of applications selected by a broadcasting receiving apparatus. Therefore, an application manufacturer does not correct an existing application but manufactures an application necessary for various kinds of broadcasting receiving apparatuses or a newly developed broadcasting receiving apparatus using the application generating and signaling method and apparatus of the present invention.

Further, the present invention provides an application processing or storing apparatus and method that select an application easily executed by a broadcasting receiving apparatus when a plurality of applications are transferred to the broadcasting receiving apparatus. Therefore, the broadcasting receiving apparatus using the present invention can select an application suitable for the broadcasting receiving apparatus although the broadcasting receiving apparatus receives the plurality of applications, which does not need to store all applications, thereby avoiding unnecessary memory consumption and providing an efficient broadcasting service.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An application generating and signaling apparatus comprising:
an application generator that generates a plurality of applications selectively executed by a broadcasting receiving apparatus and information on each of the plurality of applications; and
an application transmitter that signals the plurality of applications and the information on each of the plurality of applications,
wherein the information on each of the plurality of applications comprises information on the broadcasting receiving apparatus that executes a corresponding application, and information on the characteristics of the corresponding application.

2. The apparatus of claim 1, wherein the information on the characteristics of the corresponding application comprises information on at least one of a style of the corresponding application, a rank of a user, a language of the user, and an age of the user.

3. An application generating and signaling apparatus comprising:
an application generator that generates a plurality of applications selectively executed by a broadcasting receiving apparatus and information on each of the plurality of applications; and
an application transmitter that signals the plurality of applications and the information on each of the plurality of applications,
wherein the information on each of the plurality of applications comprises at least one of identification information and version information on the broadcasting receiving apparatus and extended information on other characteristics of the broadcasting receiving apparatus.

4. The apparatus of claim 3, wherein the extended information comprises information on at least one of recording characteristics of the broadcasting receiving apparatus, characteristics of a multi-screen manager system (MSM), a type of an input device, and graphic characteristics.

5. The apparatus of claim 4, wherein the recording characteristics of the broadcasting receiving apparatus comprises information on at least one of a number of tuners, a number of simultaneous reproductions, a number of simultaneous recordings, a number of storage media, and a size of a storage medium.

6. The apparatus of claim 4, wherein the characteristics of the MSM comprises information on at least one of whether the broadcasting receiving apparatus supports the MSM and a number of multi-screens.

7. The apparatus of claim 4, wherein the graphic characteristics comprises information on at least one of graphic resolution and color characteristics of the broadcasting receiving apparatus.

8. The apparatus of claim 3, wherein the information on each of the plurality of applications comprises a component tag that is information on a carousel corresponding to a corresponding application,
wherein the application transmitter includes an association tag that is linked to the component tag in a program map table of a stream included in the corresponding application.

9. An application selecting and executing apparatus comprising:
an application information analyzer that analyzes information on each of a plurality of applications providing a broadcasting service;
an application selector that selects an application suitable for a broadcasting receiving apparatus among the plurality of applications based on the analysis; and
an application executor that executes the selected application,
wherein the application selector compares information, on the broadcasting receiving apparatus that executes the selected application, included in the information on each of the plurality of applications with information on the broadcasting receiving apparatus that receives the selected application, if a plurality of applications are determined to be suitable for the broadcasting receiving apparatus that receives the selected application, receives information on a user's characteristics, and compares information on characteristics of the selected application included in the information on each of the plurality of applications with the information on the user's characteristics.

10. The apparatus of claim 9, wherein the information on the user's characteristics comprises information on at least one of a style of a favorite application of a user, a rank of the user, a favorite language of a user, and an age of a user.

11. An application selecting and executing apparatus comprising:
an application information analyzer that analyzes information on each of a plurality of applications providing a broadcasting service;
an application selector that selects an application suitable for a broadcasting receiving apparatus among the plurality of applications based on the analysis; and
an application executor executing the selected application,
wherein the application selector compares information, on the broadcasting receiving apparatus that executes the selected application, included in the information on each of the plurality of applications with information on the broadcasting receiving apparatus that receives the selected application, if a plurality of applications are determined to be suitable for the broadcasting receiving apparatus that receives the selected application, compares extended information on characteristics of the broadcasting receiving apparatus capable of executing the selected application included in the information on each of the plurality of applications with information on characteristics of the broadcasting receiving apparatus that receives the selected application.

12. The apparatus of claim 11, wherein the extended information comprises information on at least one of recording characteristics of the broadcasting receiving apparatus, characteristics of a multi-screen manager system (MSM), a type of an input device, and graphic characteristics.

13. The apparatus of claim 12, wherein the recording characteristics of the broadcasting receiving apparatus comprises information on at least one of a number of tuners, a number of simultaneous reproductions, a number of simultaneous recordings, a number of storage media, and a size of a storage medium.

14. The apparatus of claim 12, wherein the characteristics of the MSM comprises information on at least one of whether the broadcasting receiving apparatus supports the MSM and a number of multi-screens.

15. The apparatus of claim 12, wherein the graphic characteristics comprise information on at least one of graphic resolution and color characteristics of the broadcasting receiving apparatus.

16. An application selecting and storing apparatus comprising:
an application information analyzer that analyzes information on each of a plurality of applications providing a broadcasting service;
an application selector that selects at least one application suitable for a broadcasting receiving apparatus among the plurality of applications based on the analysis; and
an application storage unit that stores the selected at least one application.

17. The apparatus of claim 16, wherein the application selector compares information on the broadcasting receiving apparatus capable of executing a corresponding application included in the information on each of the plurality of applications with information on the broadcasting receiving apparatus that receives the selected at least one application.

18. The apparatus of claim 16, wherein the application selector compares the information on the broadcasting receiving apparatus capable of executing a corresponding application included in the information on each of the plurality of applications with information on the broadcasting receiving apparatus that receives the selected at least one application and information on at least one of other broadcasting receiving apparatuses of a network to which the broadcasting receiving apparatus that receives the selected at least one application belongs.

19. The apparatus of claim 16, wherein the application selector compares the information on the broadcasting receiving apparatus capable of executing a corresponding application included in the information on each of the plurality of applications with information on another broadcasting receiving apparatus that requests to store the selected at least one application.
